(19) United States
(12) Patent Application Publication
(10) Pub. No.: US 2020/0133672 A1
(43) Pub. Date: Apr. 30, 2020

(54) HYBRID AND EFFICIENT APPROACH TO ACCELERATE COMPLICATED LOOPS ON COARSE-GRAINED RECONFIGURABLE ARRAYS (CGRA) ACCELERATORS

(71) Applicant: Arizona Board of Regents on behalf of Arizona State University, Scottsdale, AZ (US)

(72) Inventors: Mahesh Balasubramanian, Tempe, AZ (US); Shail Dave, Tempe, AZ (US); Aviral Shrivastava, Tempe, AZ (US); Reiley Jeyapaul, Suffolk (GB)

(21) Appl. No.: 16/172,254

(22) Filed: Oct. 26, 2018

(51) Int. Cl. G06F 9/38; G06F 12/0862; G06F 12/0875

(52) U.S. Cl. CPC G06F 9/3804; G06F 12/0875; G06F 12/0862; G06F 9/3842

(57) ABSTRACT

A coarse-grained reconfigurable array includes a processing element array, instruction memory circuitry, data memory circuitry, and an instruction fetch unit. The processing element array includes a number of processing elements. The instruction memory circuitry is coupled to the processing element array and configured to store a set of instructions. During each one of a number of processing cycles, the instruction memory circuitry provides instructions from the set of instructions to the processing elements. The instruction fetch unit is coupled to the processing element array and the instruction memory circuitry and configured to receive a result of a conditional instruction evaluated by one of the processing elements and provide the instruction fetch signals based at least in part on the result of the conditional instruction such that only instructions associated with a correct branch of the conditional instruction are provided to the plurality of processing elements.

### GOVERNMENT SUPPORT

This invention was made with government support under 1055094, 1525855 and 1723476 awarded by the National Science Foundation. The government has certain rights in the invention.

### FIELD OF THE DISCLOSURE

The present disclosure relates to systems and methods for efficiently accelerating general purpose applications with complicated loops using coarse-grained reconfigurable arrays.

### BACKGROUND

Accelerators are used to accelerate specialized or computationally-intensive sections of applications. A coarse-grained reconfigurable array (CGRA) is one type of accelerator that is programmable, yet power efficient. While CGRAs have conventionally been used for special-purpose applications, their programmability and power efficiency has resulted in a push to use CGRAs for general-purpose applications. However, general-purpose applications often include computationally-intensive loops featuring several levels of nested loops and conditionals. Several compiler techniques have been developed to map loops and conditionals onto a CGRA in an efficient manner. However, these techniques have not been able to efficiently map complex loops and conditionals (e.g., nested loops and loops containing nested conditionals, etc.) onto a CGRA. Accordingly, there is a need for systems and methods for mapping complex loops and conditionals onto a CGRA in an efficient manner.

### SUMMARY

In one embodiment, a coarse-grained reconfigurable array includes a processing element array, instruction memory circuitry, data memory circuitry, and an instruction fetch unit. The processing element array includes a number of processing elements. The instruction memory circuitry is coupled to the processing element array and configured to store a set of instructions. During each one of a number of processing cycles, the instruction memory circuitry provides instructions from the set of instructions to the processing elements. The instruction fetch unit is coupled to the processing element array and the instruction memory circuitry and configured to receive a result of a conditional instruction evaluated by one of the processing elements and provide the instruction fetch signals based at least in part on the result of the conditional instruction such that only instructions associated with a correct branch of the conditional instruction are provided to the plurality of processing elements. By communicating the conditional outcome by the processing element array to the instruction fetch unit, only the correct instruction of the conditional paths of the loops are evaluated, thereby increasing the efficiency of the coarse-grained reconfigurable array.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 illustrates a coarse-grained reconfigurable array (CGRA) according to one embodiment of the present disclosure.

FIG. 2 illustrates details of a CGRA according to one embodiment of the present disclosure.

FIG. 3 illustrates a method for compiling code for efficient mapping onto a CGRA according to one embodiment of the present disclosure.

FIGS. 4A-4E illustrate a method for compiling code for efficient mapping onto a CGRA according to one embodiment of the present disclosure.

FIG. 5 illustrates a system for generating instructions for CGRAs according to one embodiment of the present disclosure.

FIGS. 6A-6D illustrate a method for compiling code for efficient mapping onto a CGRA according to one embodiment of the present disclosure.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

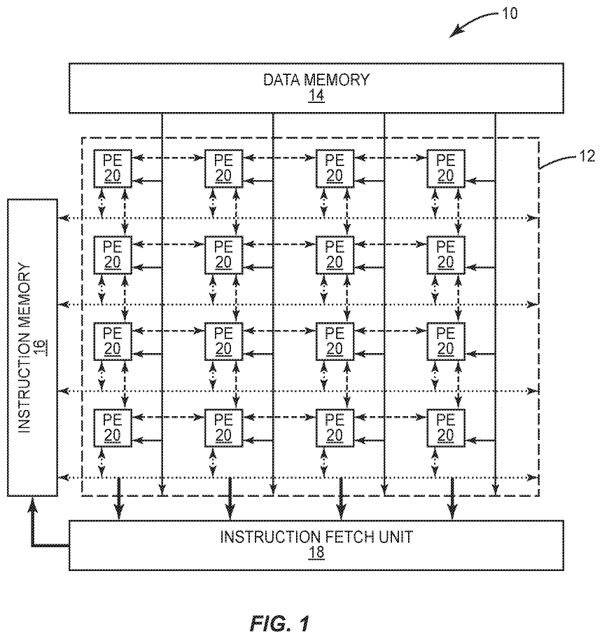

FIG. 1 shows a coarse-grained reconfigurable array (CGRA) 10 according to one embodiment of the present disclosure. The CGRA 10 includes a processing element array 12, data memory circuitry 14, instruction memory circuitry 16, and an instruction fetch unit 18. The processing element array 12 includes a number of processing elements 20 coupled to one another via a two-dimensional mesh (connections between the processing elements 20). The data memory circuitry 14, the instruction memory circuitry 16, and the instruction fetch unit 18 are coupled to the processing elements 20 in the processing element array 12. While not shown, a memory management unit may be coupled to the data memory circuitry 14 and the instruction memory circuitry 16 in order to control one or more operating characteristics thereof.

The instruction memory circuitry 16 stores a set of instructions to be evaluated by the CGRA 10. As discussed below, the set of instructions may include one or more loops. The data memory circuitry 14 stores data that may be operated on by the set of instructions. During each one of a number of processing cycles, instructions from the instruction memory circuitry 16, and, as necessary, data from the data memory circuitry 14, are provided to the processing elements 20. Specifically, in a single processing cycle each one of the processing elements receive instructions to evaluate from the instruction memory. Based on mapping performed by a compiler, some processing elements receive useful operations to evaluate and other processing elements receive no-operation (no-op) instructions. When data is acted on by the instruction of one of the processing elements 20, the data may be provided from the data memory circuitry 14, from another processing element 20, or from a register file in the processing element 20 (stored during a previous processing cycle). Each processing element 20 evaluates the instruction provided to it and may provide a result of the evaluation to a register file in the processing element 20, to another processing element 20, to the data memory circuitry 14, to the instruction fetch unit 18, or to multiple sources. The instruction fetch unit 18 provides instruction fetch signals to the instruction memory 16. These instruction fetch signals determine the instructions provided to the processing elements 20 during a processing cycle.

In conventional CGRAs, instruction memory circuitry provides instructions to the processing elements in a sequential manner. In other words, instructions from the instruction memory circuitry are provided to the processing elements in each processing cycle (i.e., a CGRA cycle), in exactly the order they are stored. Accordingly, the instructions provided to the processing elements during a processing cycle are determined only by the layout of the instructions in memory. Such an approach limits the performance gain of conventional CGRAs over standard processors. Since there is no way to dynamically provide instructions to the processing elements based on the result of instructions evaluated by the processing elements, conventional CGRAs must rely upon full predication or partial predication to evaluate loops with conditionals. Full predication and partial predication require the processing elements to evaluate every instruction in every path of a condition, and further introduce significant overhead in the form of additional select instructions. This limits the efficiency of conventional CGRAs when evaluating loops with conditionals. This is especially true when the loops and conditionals are complex (e.g., nested).

In contrast to conventional CGRAs, the instruction fetch unit 18 of the CGRA 10 discussed herein provides instruction fetch signals that allow for skipping instructions stored in the instruction memory circuitry 16 to be provided to the processing elements 20 in subsequent processing cycles. More specifically, the instruction fetch unit 18 provides instruction fetch signals to the instruction memory circuitry 16 such that instructions are dynamically provided based on the result of one or more conditional instructions evaluated by the processing elements 20.

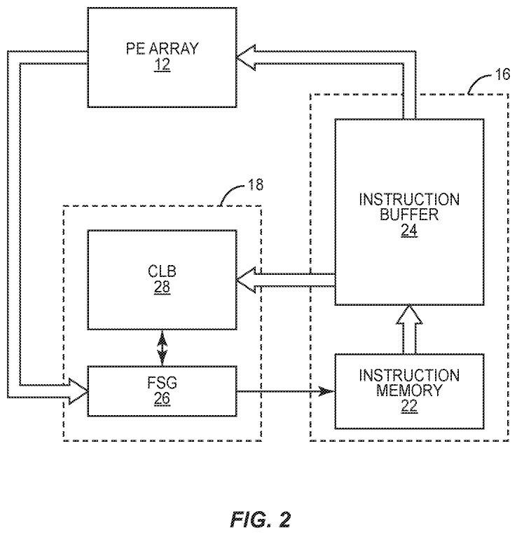

Details of the instruction memory circuitry 16 and the instruction fetch unit 18 are shown in FIG. 2. The processing element array 12 is also shown for context. The instruction memory circuitry 16 includes an instruction memory 22 and an instruction buffer 24. The instruction fetch unit 18 includes fetch signal generator circuitry 26 and a conditional lookaside buffer 28. The instruction memory 22 is coupled to the instruction buffer 24, the instruction buffer 24 is coupled to the processing element array 12, the instruction buffer 24 is coupled to the conditional lookaside buffer 28, the processing element array 12 is coupled to the fetch signal generator circuitry 26, and the instruction memory 22 is coupled to the fetch signal generator circuitry 26, which is in turn coupled to the conditional lookaside buffer 28.

In operation, the instruction memory 22 stores the set of instructions. The instructions are laid out in a specific manner when compiled, and include instruction skip values associated with conditional instructions. Details regarding how the instructions are skipped are discussed below. In general, instructions are skipped based on the outcome of conditional statements evaluated by one or more processing elements at runtime. The fetch signal generator circuitry 26 generates instruction fetch signals, which are provided to the instruction memory 22 and cause the instruction memory to load instructions from the instruction memory 22 into the instruction buffer 24. When a conditional instruction is loaded into the instruction buffer 24, the instruction or a reference to the instruction and an instruction skip value associated with the instruction are provided from the instruction memory 22 to the conditional lookaside buffer 28. Eventually, the conditional instruction is provided from the instruction memory 22 to one of the processing elements 20 in the processing element array 12. When the conditional instruction is evaluated by one of the processing elements 20 in the processing element array 12, the result is provided to the fetch signal generator circuitry 26. The fetch signal generator circuitry 26 uses the result of the conditional instruction along with the instruction skip value for the conditional instruction in the conditional lookaside buffer 28 to determine a number of instructions in the instruction memory 22 to skip, thereby allowing only those instructions associated with a single conditional branch to be evaluated. This may be done an arbitrary number of times, allowing for the application of these principles to nested conditionals and nested loops. Instructions associated with conditional branches that are never reached during execution are not evaluated, and no select instructions are needed. Accordingly, the CGRA 10 is able to efficiently evaluate applications with arbitrarily nested loops and loops with nested conditionals.

As will be discussed below, the set of instructions is laid out in the instruction memory 22 such that the number of processing cycles to fully evaluate each branch created by a conditional instruction are symmetrical. Further, an instruction skip value is associated with each conditional instruction. If the result of the conditional instruction is true, the fetch signal generator circuitry 26 provides instruction fetch signals such that the instruction memory 22 loads only the instructions associated with the true branch of the conditional instruction from the set of instructions into the memory buffer 24 and skips the instructions associated with the false branch of the conditional instruction (does not load them into the memory buffer 24). Alternatively, if the result of the conditional instruction is false, the fetch signal generator circuitry 26 provides instruction fetch signals such that the instruction memory 22 skips the instructions associated with the true branch of the conditional instruction (does not load them into the memory buffer 24) and loads the instructions associated with the false branch of the conditional instruction from the set of instructions into the memory buffer 24.

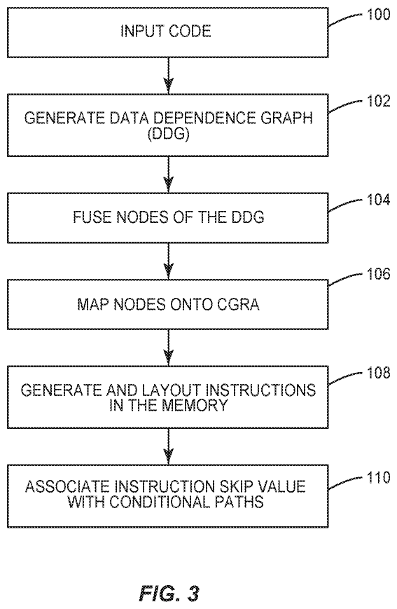

FIG. 3 is a flow diagram illustrating a method for compiling code for efficient mapping onto a CGRA according to one embodiment of the present disclosure. The method begins with input code (step 100). From the input code, a data dependency graph is generated (step 102). To effectively utilize the instruction fetch unit 18 hardware discussed above, the conditional instructions in the data dependency graph are fused together (step 104). The resultant data dependence graph is mapped onto the CGRA (step 106). After the mapping, the instructions are generated by an instruction generation routine (step 108) which lays out the instructions in memory to aid the instruction fetch unit 18 hardware discussed above with respect to FIG. 2 to execute only instructions from the correct path of the conditional based on the branch outcome. An instruction skip value is associated with each conditional instruction in the input code (step 110). Details of each one of these steps are discussed below.

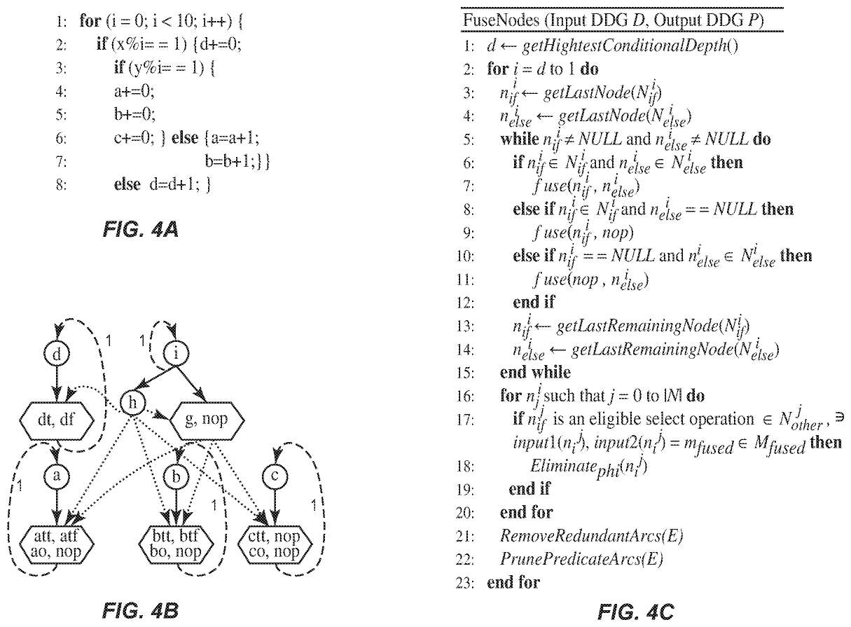

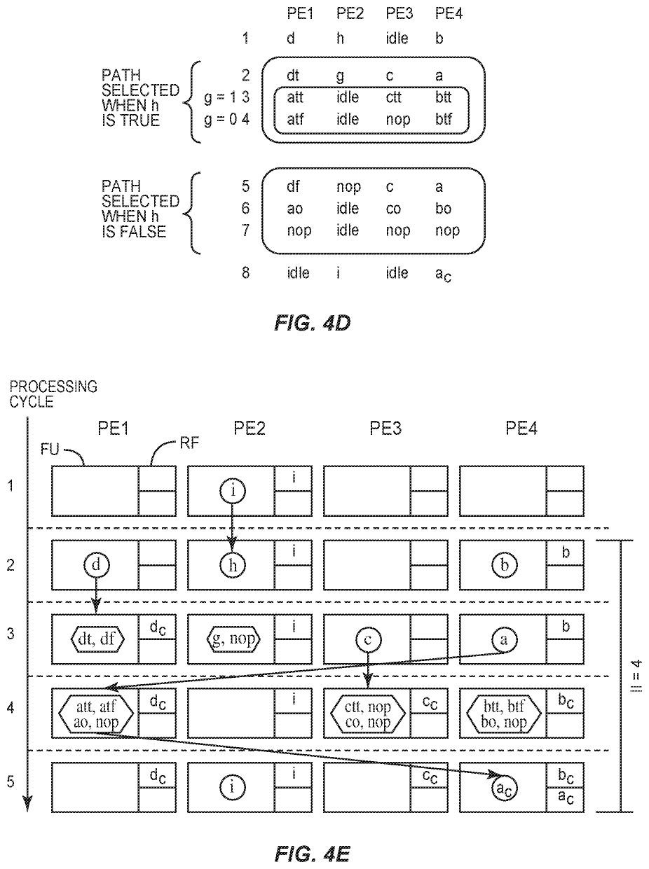

FIG. 4A illustrates input code including a loop with nested conditionals. The following figures illustrate how this input code may be compiled into a set of instructions that can be efficiently evaluated by the CGRA 10 discussed above. FIG. 4B illustrates a data dependency graph generated from the input code. In the data dependency graph, each node represents an operation in the loop and edges represent the dependency between the operations. FIG. 4C illustrates pseudocode to generate the data dependency graph from the input code. The pseudocode begins by getting the depth of the most nested conditional in a nested conditional. Iterating from the instructions in the most nested conditional to those in the least nested conditional, the pseudocode describes fusing instructions for each branch of the conditional with one another. When conditional branches are asymmetrical (i.e., when there are more instructions in one conditional branch than another), the instructions in the longer conditional branch are fused with no-op instructions. As discussed herein, “fusing” instructions means laying the instructions out in memory so that they will be provided to the same processing element 20 if executed. However, due to the operation of the instruction fetch unit 18 described above, only the instructions for the appropriate conditional branch will be provided to the processing element 20.

The operations in the data dependency graph shown in FIG. 4B are abbreviated. The circle nodes represent an operation on the variable contained therein outside of any conditional (i.e., the variable i is incremented on each iteration of the loop). Fused nodes in the data dependency graph are illustrated by a polyhedron having pointed sides. In these fused nodes, only one of the operations within the node will be evaluated. Which operation is evaluated is dependent upon the input provided to the node. In fused nodes having more than two operations inside, the one of the operations evaluated is dependent upon the branch outcome. The leading letters in the fused nodes represent the variable on which the operation is performed, while the trailing t's and f's represent the state of the conditionals in which these operations are located (true and false, respectively), in order from innermost to outermost. Trailing o's represent no change in the value of the variable (i.e., the value of the variable is preserved in the processing cycle). The letter h represents the value of the conditional x % i==1, and the letter g represents the value of the conditional y % i==1.

FIG. 4D illustrates a portion of exemplary instructions compiled from the input code in FIG. 4A. In particular, FIG. 4D illustrates a single iteration of the for loop in the input code in FIG. 4A. The instructions assume a processing element array 12 including four processing elements 20 (i.e., a 2×2 array of processing elements). Each line of the instructions represents the instructions evaluated in a single processing cycle of the CGRA 10. Each column of each line of the instructions are mapped to a particular processing element 20 in the processing element array 12, as illustrated by the column headers PE1 through PE4. The result of the instructions shown are described below.

In the first line, a first processing element PE1 operates on variable d. Specifically, the value of d is fetched from memory. A second processing element PE2 evaluates h, which, as described above is the value of the conditional x % i==1. The value of h is provided to the instruction fetch unit 18 as discussed above. A third processing element PE3 remains idle. As discussed herein, remaining idle may be equivalent to performing a no-op instruction. A fourth processing element PE4 operates on variable b, specifically fetching the value of b from memory.

In the second line, the first processing element PE1 performs the operation on d specified by the input code if h is true. Specifically, the first processing element PE1 performs the operation d+=0. The second processing element PE2 evaluates g, which, as discussed above is the value of the conditional y % i==1. The value of g is provided to the instruction fetch unit 18 as discussed above. The third processing element PE3 operates on variable c, specifically fetching the value of c from memory. The fourth processing element PE4 operates on variable a, specifically fetching the value of a from memory.

In the third line, the first processing element PE1 performs the operation on a specified by the input code if both h and g are true. Specifically, the first processing element PE1 performs the operation a+=0. The second processing element PE2 remains idle. The third processing element PE3 performs the operation on c specified by the input code if both h and g are true. Specifically, the third processing element performs the operation c+=0. The fourth processing element PE4 performs the operation on b specified by the input code if both h and g are true. Specifically, the fourth processing element PE4 performs the operation b+=0.

In the fourth line, the first processing element PE1 performs the operation on a specified by the input code if h is true and g is false. Specifically, the first processing element PE1 performs the operation a=a+1. The second processing element PE2 remains idle. The third processing element PE3 performs a no-op. The fourth processing element PE4 performs the operation on b specified by the input code if h is true and g is false. Specifically, the fourth processing element PE4 performs the operation b=b+1.

In the fifth line, the first processing element PE1 performs the operation on d specified by the input code if h is false. Specifically, the first processing element PE1 performs the operation d=d+1. The second processing element PE2 performs a no-op. The third processing element PE3 operates on variable c, specifically fetching the value of c from memory. The fourth processing element operates on variable a, specifically fetching the value of a from memory.

In the sixth line, the first processing element retains the value of a (does not operate on a, but retains its value). The second processing element PE2 remains idle. The third processing element PE3 retains the value of c. The fourth processing element PE4 retains the value of b.

In the seventh line, the first processing element PE1, the third processing element PE3, and the fourth processing element PE4 perform no-ops, while the second processing element PE2 remains idle.

In the eighth line, the loop begins again. The first processing element PE1 remains idle. The second processing element PE2 performs an operation on i, specifically incrementing the value of i. The third processing element PE3 remains idle. The fourth processing element operates on variable a, specifically receiving the value of a evaluated in a previous processing cycle by another processing element.

The instructions in lines 2-4 and 5-7 represent fused nodes in the data dependency graph shown in FIG. 4B. For example, in line 2 the first processing element PE1 performs the operation on d specified by the input code if h is true, while in line 5 the first processing element PE1 performs the operation on d specified by the input code if h is false. The instructions are laid out such that the operation performed on d is always evaluated by the first processing element PE1. As discussed above, however, only one of these operations will actually be performed during execution. Lines 2-4 and 5-7 represent different instructions of the branches for the conditional instruction h. If h is true, lines 2-4 should be provided to the processing elements 20 and evaluated. If h is false, lines 5-7 should be provided to the processing elements 20 and evaluated. The instruction skip value for this branch is three, since each one of the branches includes three lines, or requires three processing cycles, to complete.

Lines 3 and 4 represent different instructions of the branches for conditional instruction g. If g is true, line 3 should be provided to the processing elements 20 and evaluated. If g is false, line 4 should be provided to the processing elements 20 and evaluated. The instruction skip value for this branch is one, since each one of the branches includes one line, or requires one processing cycle, to complete.

As shown, when a particular branch is asymmetrical (e.g., when a variable is acted upon only in one state of a conditional), a no-op is paired with the operation in one branch so that the branches are equal in length. One example of this is shown for the third processing element PE3 in lines 3 and 4. Referring back to FIG. 4A, if both h and g are true, the operation c+=0 is performed. If h is true and g is false, nothing is done to c. Accordingly, the operation ctt in line 3, which represents the operation c+=0 as discussed above, is paired with a no-op in line 4 so that the instructions can be properly laid out.

Referring back to the CGRA 10 discussed above, the instructions illustrated in FIG. 4D may be stored in the instruction memory 22. The first line of the instructions may be loaded into the instruction buffer 24. The first line includes conditional instruction h, and thus this instruction or a reference thereto along with an instruction skip value for this instruction (three, as discussed above) are loaded into the conditional lookaside buffer 28. When the instructions in the first line are provided to the processing elements 20 and evaluated, a result of h is provided to the fetch signal generator circuitry 26. The fetch signal generator circuitry 26 then uses the instruction skip value in the conditional lookaside buffer to generate instruction fetch signals to determine the next lines of the instructions to be transferred from the instruction memory 22 to the instruction buffer 24. If h is true, the instruction fetch signals cause the instruction memory 22 to load lines 2-4 of the instructions into the instruction buffer 24 and skip lines 5-7. Conversely, if h is false, the instruction fetch signals cause the instruction memory 22 to skip lines 2-4 and load lines 5-7 into the instruction buffer 24.

Notably, while the instructions shown in FIG. 4D is laid out in lines and columns to facilitate the explanation of the concepts described herein, the instructions in the instructions may be laid out in any number of different configurations. Those skilled in the art will appreciate that the particular layout of the instructions can be arbitrary so long as they can be consistently parsed and mapped back to a desired configuration in which fused instructions are provided to the same processing element and predictably separated from one another so as to be dynamically provided during runtime.

FIG. 4E illustrates how the code shown in FIG. 4A can be mapped onto a 2×2 array of processing elements after fusing of conditional operations. Specifically, FIG. 4E illustrates each of the processing elements PE and the operations mapped onto them for each one of a number of processing cycles. Each processing element PE is illustrated and has a register file RF having space to store two values. Notably, the particular mapping of the instructions to the processing elements PE is merely exemplary. Those skilled in the art will readily appreciate that many different ways to map the instructions onto an array of processing elements exist, all of which are contemplated herein. FIG. 4E illustrates that the nested loop described in FIG. 4A can be mapped onto a 2×2 CGRA with an initiation interval of four.

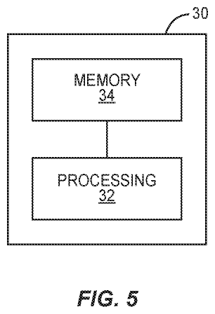

The set of instructions illustrated above in FIG. 4D may be generated by a compiler system 30 such as the one shown in FIG. 5. The compiler system 30 includes processing circuitry 32 and a memory 34. The memory 34 stores instructions, which, when executed by the processing circuitry 32 cause the compiler system 30 to generate the set of instructions as described above with respect to FIG. 3. Further, code for generating the set of instructions as described above may be stored on a non-transitory computer medium, which may be provided in a computing system to generate the set of instructions.

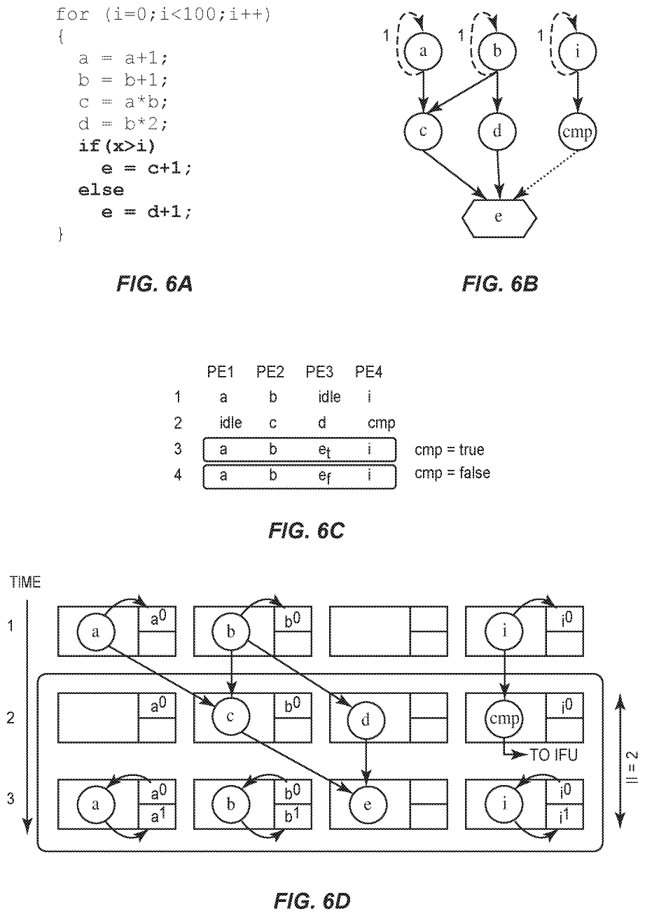

FIG. 6A illustrates input code including a loop with a conditional. The following figures illustrate how this input code may be compiled into a set of instructions that can be efficiently evaluated by the CGRA discussed above. FIG. 6B illustrates a data dependency graph generated from the input code. As discussed above, in the data dependency graph each node represents an operation in the loop and edges represent the dependency between the operations. FIG. 6C illustrates a portion of exemplary instructions compiled from the input code in FIG. 6A. In particular, FIG. 6C illustrates a single iteration of the loop in the input code shown in FIG. 6A. The instructions assume a processing element array 12 including four processing elements 20 (i.e., a 2×2 array of processing elements). Each line of instructions represents the instructions evaluated in a single processing cycle of the CGRA 10. Each column of each line of the instructions is mapped to a particular processing element in the processing element array 12, as illustrated by the column headers PE1 through PE4. The result of the instructions shown are described below.

In the first line, a first processing element PE1 operates on variable a. Specifically, the first processing element PE1 performs the operation a=a+1. A second processing element PE2 operates on variable b. Specifically, the second processing element PE2 performs the operation b=b+1. A third processing element PE3 remains idle. A fourth processing element operates on variable i. Specifically, the fourth processing element PE4 performs the operation i++.

In the second line, the first processing element PE1 remains idle. The second processing element PE2 operates on variable c. Specifically, the second processing element PE2 performs the operation c=a*b. The third processing element PE3 operates on variable d. Specifically, the third processing element PE3 performs the operation d=b*2. The fourth processing element PE4 evaluates cmp, which is the value of the conditional x>i.

In the third line, the first processing element PE1 operates on variable a. Specifically, the first processing element PE1 performs the operation a=a+1. The second processing element PE2 operates on variable b. Specifically, the second processing element PE2 performs the operation b=b+1. The third processing element PE3 operates on variable e. Specifically, the third processing element PE3 performs the operation on e if cmp is true, which is e=c+1. The fourth processing element operates on variable i. Specifically, the fourth processing element PE4 performs the operation i++.

In the fourth line, the first processing element PE1 operates on variable a. Specifically, the first processing element PE1 performs the operation a=a+1. The second processing element PE2 operates on variable b. Specifically, the second processing element PE2 performs the operation b=b+1. The third processing element PE3 operates on variable e. Specifically, the third processing element PE3 performs the operation on e if cmp is false, which is e=d+1. The fourth processing element operates on variable i. Specifically, the fourth processing element PE4 performs the operation i++.

The instructions shown on lines 3 and 4 represent fused nodes in the data dependency graph shown in FIG. 6B. For example, in line 3 the third processing element PE3 performs the operation on e specified by the input code if cmp is true, while in line 4 the third processing element PE3 performs the operation on e specified by the input code if cmp is false. The instructions are laid out such that the operation performed on e is always evaluated by the third processing element PE3. As discussed above, however, only one of these operations will actually be performed during execution. Lines 3 and 4 represent different instructions of the branches for the conditional instruction cmp. If cmp is true, line 3 should be provided to the processing elements 20 and evaluated. If cmp is false, line 4 should be provided to the processing elements 20 and evaluated. The instruction skip value for this branch is one, since each of the branches includes one line, or requires one processing cycle, to complete.

Referring back to the CGRA 10 discussed above, the instructions related to FIG. 4C may be stored in the instruction memory 22. The first line of the instructions may be loaded into the instruction buffer 24, followed by the second line of the instructions. The second line includes conditional instruction cmp, and thus this instruction or a reference thereto along with an instruction skip value for this instruction (one, as discussed above), are loaded into the conditional lookaside buffer 28. When the instructions in the second line are provided to the processing elements 20 and evaluated, a result of cmp is provided to the fetch signal generator circuitry 26. The fetch signal generator circuitry 26 then uses the instruction skip value in the conditional lookaside buffer to generate instruction fetch signals to determine the next lines of the instructions to be transferred from the instruction memory 22 to the instruction buffer 24. If cmp is true, the instruction fetch signals cause the instruction memory 22 to load line 3 into the instruction buffer 24 and skip line 4. Conversely, if cmp is false, the instruction fetch signals cause the instruction memory 22 to skip line 3 and load line 4 into the instruction buffer 24.

FIG. 6D illustrates how the code shown in FIG. 6A can be mapped onto a 2×2 array of processing elements after fusing of conditional operations. Specifically, FIG. 6D illustrates each of the processing elements PE and the operations mapped onto them for each one of a number of processing cycles. Each processing element PE has a register file RF having space to store two values. Notably, the particular mapping of the instructions to the processing elements is merely exemplary. Those skilled in the art will readily appreciate that many different ways to map the instructions onto an array of processing elements exist, all of which are contemplated herein. FIG. 6D illustrates that the loop with a conditional described in FIG. 6A can be mapped onto a 2×2 CGRA with an initiation interval of two.

Those skilled in the art will recognize improvements and modifications to the preferred embodiments of the present disclosure. All such improvements and modifications are considered within the scope of the concepts disclosed herein and the claims that follow.

What is claimed is:

1. A coarse-grained reconfigurable array comprising:
a processing element array comprising a plurality of processing elements;
instruction memory circuitry coupled to the processing element array and configured to:
store a set of instructions; and
during each one of a plurality of processing cycles, provide instructions from the set of instructions to the plurality of processing elements based on instruction fetch signals; and
an instruction fetch unit coupled to the processing element array and the instruction memory circuitry and configured to:
receive a result of a conditional instruction evaluated by one of the plurality of processing elements; and
provide the instruction fetch signals based at least in part on the result of the conditional instruction such that only instructions associated with a correct branch of the conditional instruction are provided to the plurality of processing elements.

2. The coarse-grained reconfigurable array of claim 1 wherein the instruction fetch unit comprises a conditional lookaside buffer such that:
the conditional lookaside buffer stores an instruction skip value associated with the conditional instruction; and
the instruction fetch unit is configured to provide the instruction fetch signals based on the result of the conditional instruction and the instruction skip value associated with the conditional instruction.

3. The coarse-grained reconfigurable array of claim 2 wherein the instruction fetch signals cause the instruction memory circuitry to skip a number of instructions in the instruction memory based on the instruction skip value, such that these instructions are not provided to the processing elements.

4. The coarse-grained reconfigurable array of claim 1 wherein the instruction memory circuitry comprises:
an instruction buffer configured to provide the instructions from the set of instructions to the plurality of processing elements; and
an instruction memory configured to store the set of instructions and provide instructions from the set of instructions to the instruction buffer based on the instruction fetch signals.

5. The coarse-grained reconfigurable array of claim 4 wherein the instruction fetch unit comprises a conditional lookaside buffer such that:
the conditional lookaside buffer stores an instruction skip value associated with the conditional instruction; and
the instruction fetch unit is configured to provide the instruction fetch signals based on the result of the conditional instruction and the instruction skip value associated with the conditional instruction.

6. The coarse-grained reconfigurable array of claim 5 wherein the instruction fetch signals cause the instruction memory circuitry to skip a number of instructions in the instruction memory based on the instruction skip value, such that these instructions are not provided to the processing elements.

7. The coarse-grained reconfigurable array of claim 6 wherein the instruction fetch signals cause the instruction memory to selectively provide instructions from the set of instructions to the instruction buffer.

8. The coarse-grained reconfigurable array of claim 5 wherein the instruction buffer is configured to provide the instruction skip value to the conditional lookaside buffer when the conditional instruction is provided from the instruction memory to the instruction buffer.

9. The coarse-grained reconfigurable array of claim 1 wherein the conditional instruction is a nested conditional instruction.

10. The coarse-grained reconfigurable array of claim 1 wherein the instruction fetch unit is configured to provide the instruction fetch signals such that only instructions from a single branch of a nested conditional instruction are provided from the instruction memory circuitry to the plurality of processing elements.

11. A method comprising:
receiving input code;
generating a set of instructions from the input code, wherein the set of instructions includes:
a first subset of instructions;
a second subset of instructions, wherein:
a number of instructions in the first subset of instructions are equal to a number of instructions in the second subset of instructions; and
the first subset of instructions includes instructions to be evaluated if a conditional instruction is true and the second subset of instructions includes instructions to be evaluated if the conditional instruction is false; and
an instruction skip value associated with the first set of instructions and the second set of instructions, wherein the instruction skip value specifies a number of instructions in the first subset of instructions and the second subset of instructions.

12. The method of claim 11 wherein the conditional instruction is a nested conditional instruction.

13. The method of claim 11 wherein the generating the set of instructions comprises generating at least one no-op instruction such that the number of instructions in the first subset of instructions are equal to the number of instructions in the second subset of instructions.

14. The method of claim 13 wherein the conditional instruction is a nested conditional instruction.

15. The method of claim 11 wherein the set of instructions further includes:
a third subset of instructions; and
a fourth subset of instructions, wherein:
a number of instructions in the third subset of instructions are equal to a number of instructions in the fourth subset of instructions;
the third subset of instructions includes instructions to be evaluated if an additional conditional instruction is true and the fourth subset of instructions includes instructions to be evaluated if the additional conditional instruction is false; and
the additional conditional instruction is nested within the conditional instruction.

16. An apparatus comprising:
processing circuitry; and
a memory storing instructions, which, when executed by the processing circuitry cause the apparatus to:
receive input code;
generate a set of instructions from the input code, wherein the set of instructions includes:
a first subset of instructions,
a second subset of instructions, wherein:
a number of instructions in the first subset of instructions are equal to a number of instructions in the second subset of instructions; and
the first subset of instructions includes instructions to be evaluated if a conditional instruction is true and the second subset of instructions includes instructions to be evaluated if the conditional instruction is false; and
an instruction skip value associated with the first set of instructions and the second set of instructions, wherein the instruction skip value specifies a number of instructions in the first subset of instructions and the second subset of instructions.

17. The apparatus of claim 16 wherein the conditional instruction is a nested conditional instruction.

18. The apparatus of claim 16 wherein generating the set of instructions comprises generating at least one no-op instruction such that the number of instructions in the first subset of instructions are equal to the number of instructions in the second subset of instructions.

19. The apparatus of claim 18 wherein the conditional instruction is a nested conditional instruction.

20. The apparatus of claim 16 wherein the set of instructions further includes:
a third subset of instructions; and
a fourth subset of instructions, wherein:
a number of instructions in the third subset of instructions are equal to a number of instructions in the fourth subset of instructions;
the third subset of instructions includes instructions to be evaluated if an additional conditional instruction is true and the fourth subset of instructions includes instructions to be evaluated if the additional conditional instruction is false; and
the additional conditional instruction is nested within the conditional instruction.
